(19) United States
(12) Patent Application Publication
(10) Pub. No.: US 2018/0125016 A1
(43) Pub. Date: May 10, 2018

(54) MULTI-LEVEL HORIZONTAL AIR FLOW DISTRIBUTION SYSTEM

(71) Applicant: Stephen A. Dufresne, Calgary (CA)

(72) Inventor: Stephen A. Dufresne, Calgary (CA)

(21) Appl. No.: 15/346,075

(22) Filed: Nov. 8, 2016

(51) Int. Cl. A01G 9/24; A01G 9/18; A01G 9/20

(52) U.S. Cl. CPC A01G 9/246; A01G 9/20; A01G 9/18

(57) ABSTRACT

A multi-level horizontal air flow distribution system is provided. The air flow distribution system includes a multi-level rack, an air exchange unit, an air delivery structure and an air exhaust structure. The air exchange unit includes a blower that blows air into the air delivery structure. The air delivery structure delivers directed streams of cold air in between plants and lights supported by the multi level rack. The cold air pushes warm air produced by the lights out of the multi-level rack. The warm air rises into the air exhaust structure and may be directed to the air exchange unit to be recycled within the air flow distribution system.

### BACKGROUND OF THE INVENTION

The present invention relates to air flow within a grow room and, more particularly, to an improved air flow distribution system for multi-level growing rooms.

A grow room is a room of any size where plants are grown under controlled environmental conditions. Plants are grown with the use of artificial light. The plants in a grow room can be grown in soil, or without soil via means of hydroponic or aeroponic technology. Utilizing a building as a grow room either next to or in dense population areas is very desirable in order to provide fresh quality vegetation with higher levels of nutrition while substantially reducing your carbon foot print. Current air circulation units within grow rooms attempt to cool the entire grow room as a whole, which is inefficient and costly.

As can be seen, there is a need for an improved air flow distribution system for a multi-level grow rooms.

### SUMMARY OF THE INVENTION

In one aspect of the present invention, an air flow distribution system comprises: at least one multi-level rack comprising a first side, a second side opposite the first side, and plurality of levels, wherein each level is configured to support a plurality of plants and a plurality of lights positioned to direct light towards the plurality of plants; an air exchange unit comprising a blower; an air delivery structure receiving air from the blower, wherein the air delivery structure comprises at least a portion disposed on the first side of the multi level rack comprising a plurality of outlets positioned to deliver a stream of air in between the plurality of plants and the plurality of lights; and an air exhaust structure disposed on the second side above the at least one multi level rack and comprising at least one inlet.

In another aspect of the present invention, an air flow distribution system comprises: an air exchange unit comprising a blower; a main pipe running from the air exchange unit and receiving air from the blower; a plurality of delivery pipes running from the main pipe and disposed horizontally above and below one another, wherein each of the delivery pipes comprises a plurality of nozzles disposed along a length of the plurality of delivery pipes, wherein the nozzles are operable to deliver a directed stream of air in between a plurality of plants and a plurality of lights within a multi level rack; and an air exhaust structure comprising at least one inlet, wherein the air exhaust structure is connected to the air exchange unit and the blower forms a vacuum within the air exhaust structure.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a front view of a section of an embodiment of the present invention illustrating air flow through a portion of the system;

FIG. 3 is a cut away view taken along line 3-3 in FIG. 2;

FIG. 3A is a detailed section view of FIG. 3 illustrating a section of a pipe of the present invention;

FIG. 3B is a detailed section view of FIG. 3 illustrating an air tight connector of the sections of the pipe;

FIG. 3C is a detailed section view of FIG. 3 illustrating nozzles and a track of the pipe;

FIG. 3D is a cut away view taken along line 3D-3D in FIG. 3;

FIG. 4 is a partial side view of an embodiment of the present invention;

FIG. 5 is a cut away view taken along line 5-5 in FIG. 4;

FIG. 6 is a perspective view of an alternate embodiment of the present invention;

FIG. 6A is a detailed view of an opening of the air vent of FIG. 6; and

FIG. 7 is a schematic view of an embodiment of the present invention illustrating the control system.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a multi-level horizontal air flow distribution system. The air flow distribution system evenly delivers fresh air, cool or warm, depending on the desired indoor environment temperature regardless of the outside environment. In certain embodiments, the present invention injects cool air in between lights and plants within growing levels of multi growing racks to force the warm air created by the lights out of the growing levels into the low pressure zone between the two multi-level growing racks. The hotter air naturally rises and is captured by a return air pipe. The warmer air flows through the return air pipe to a fresh air exchange unit to be cooled and recycled to the growing levels.

After a certain period of time, the recycled air is exchanged with outside air to replenish fresh air within the growing room. The warm air returning to the air exchange unit exhausts to the outside of the growing room and new fresh air is retrieved. New fresh air entering the grow room may pass through a hepa filter system and a UV light to clean and sterilize the air. CO2 is also deliver to the plants to maintain a constant targeted PPM level for the best photosynthesis growing process.

The total cycle may be controlled by an environmental computer system. The computer system may include preprogrammed target levels for temperature, humidity levels and CO2 levels. The computer may further control scheduled air exchanges as well as each growing level's modulating damper. A temperature, humidity and CO2 sensor may be disposed in the middle level of every group of three growing levels. Each sensor delivers data to the computer and the computer controls three modulating dampers associated with the three growing rows. The upper levels within the growing room are naturally warmer because heat rises. The modulating dampers open more or less to inject more or less cooling air flow through the growing levels based on the sensor data. Due to the sensors, dampers and computer, the present invention maintains about the same amount of air flow, temperature, humidity and CO2 levels within each level.

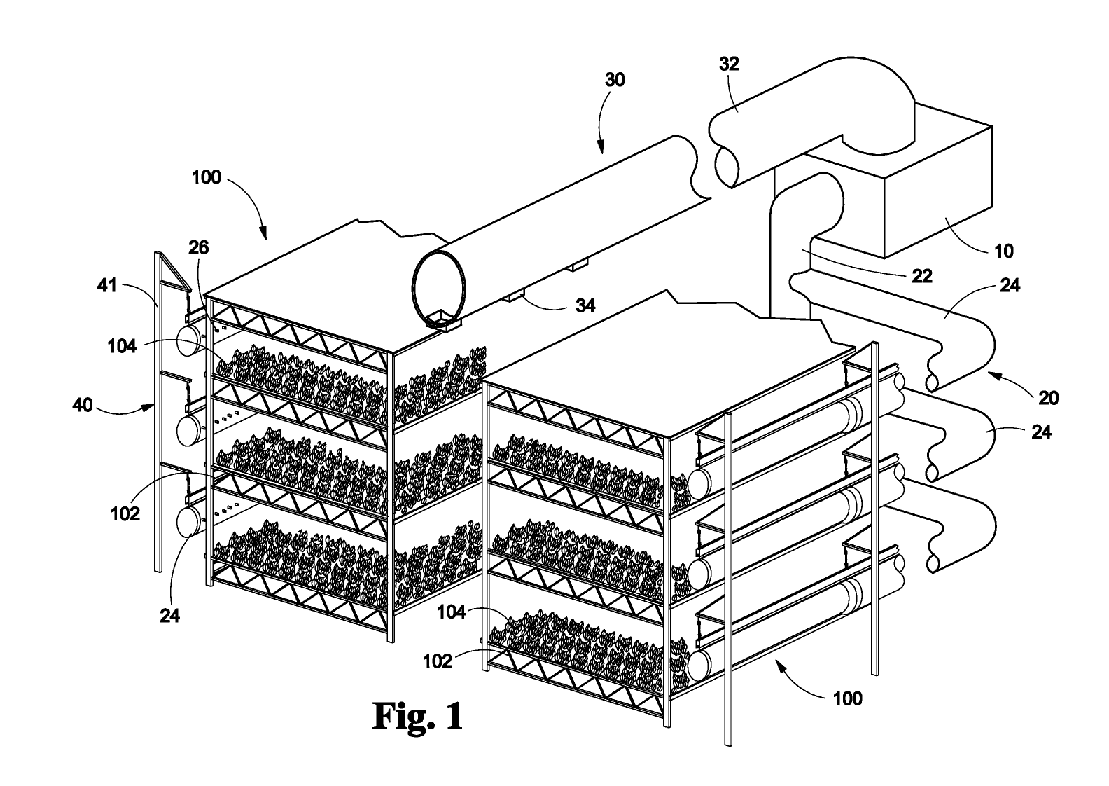

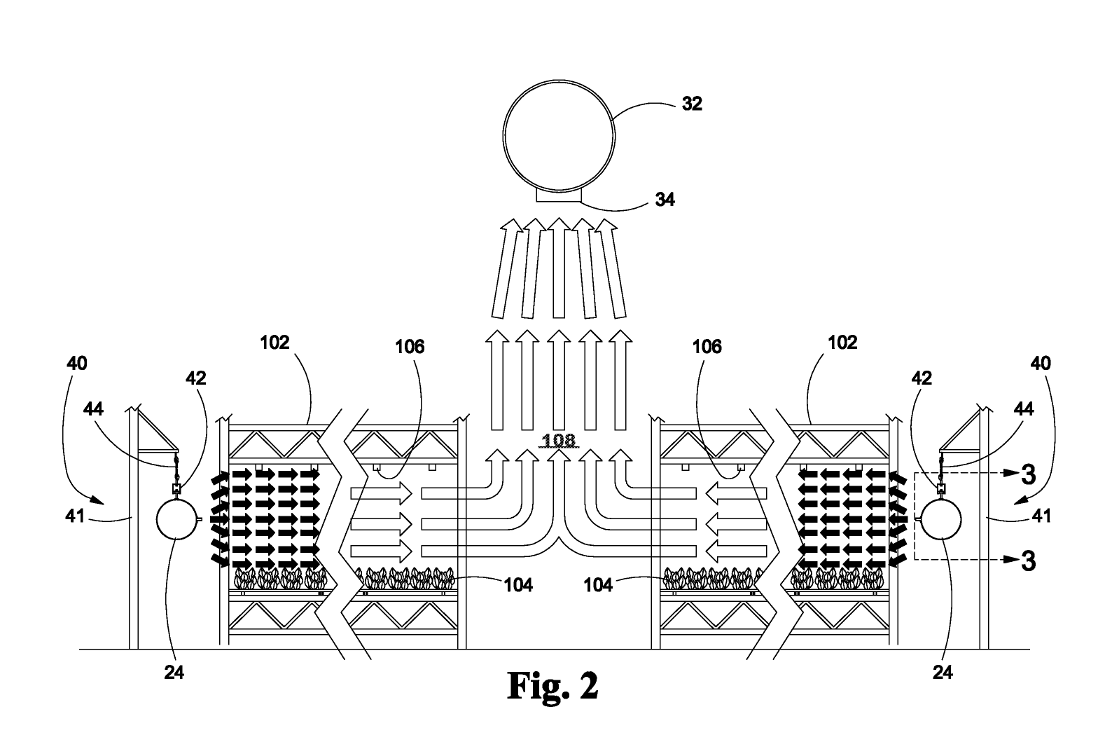

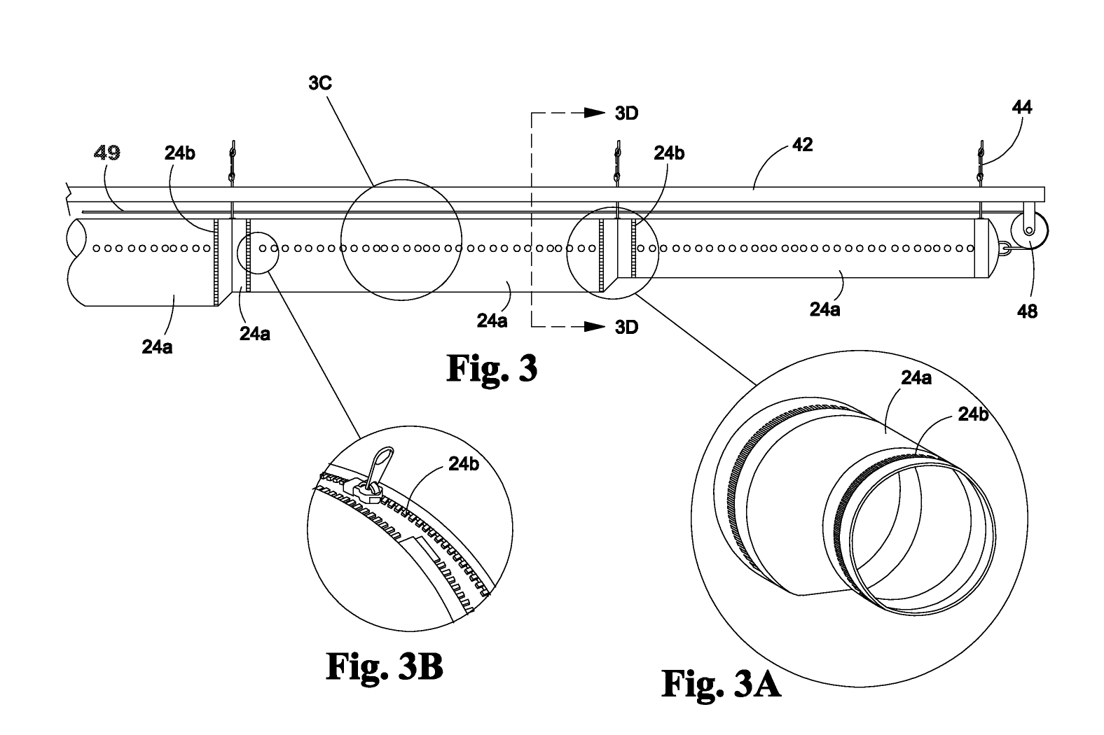

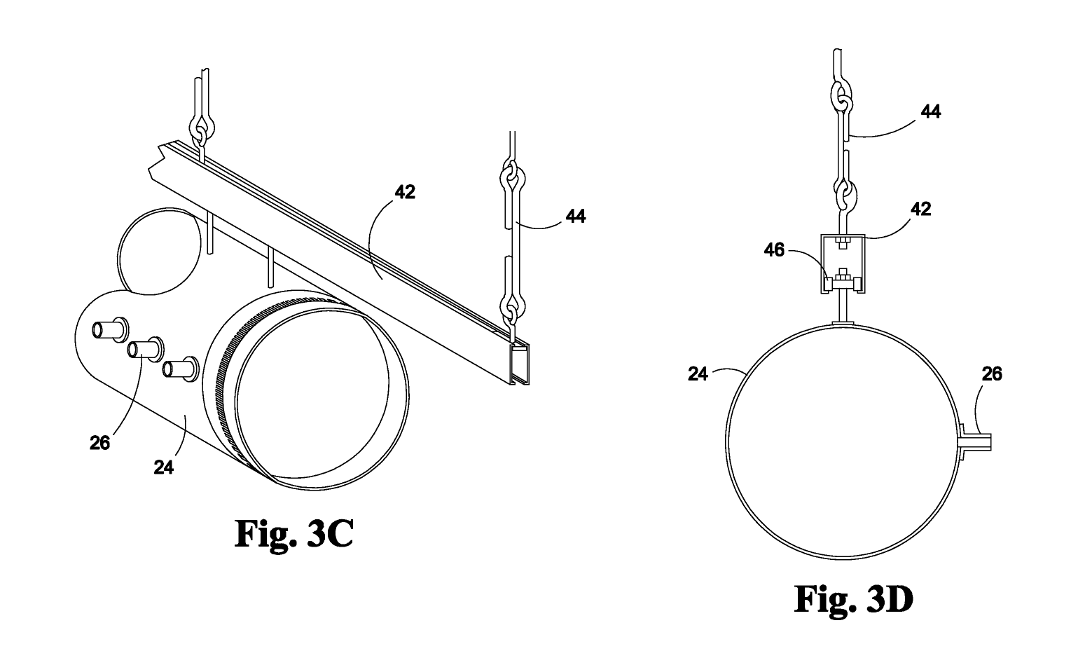

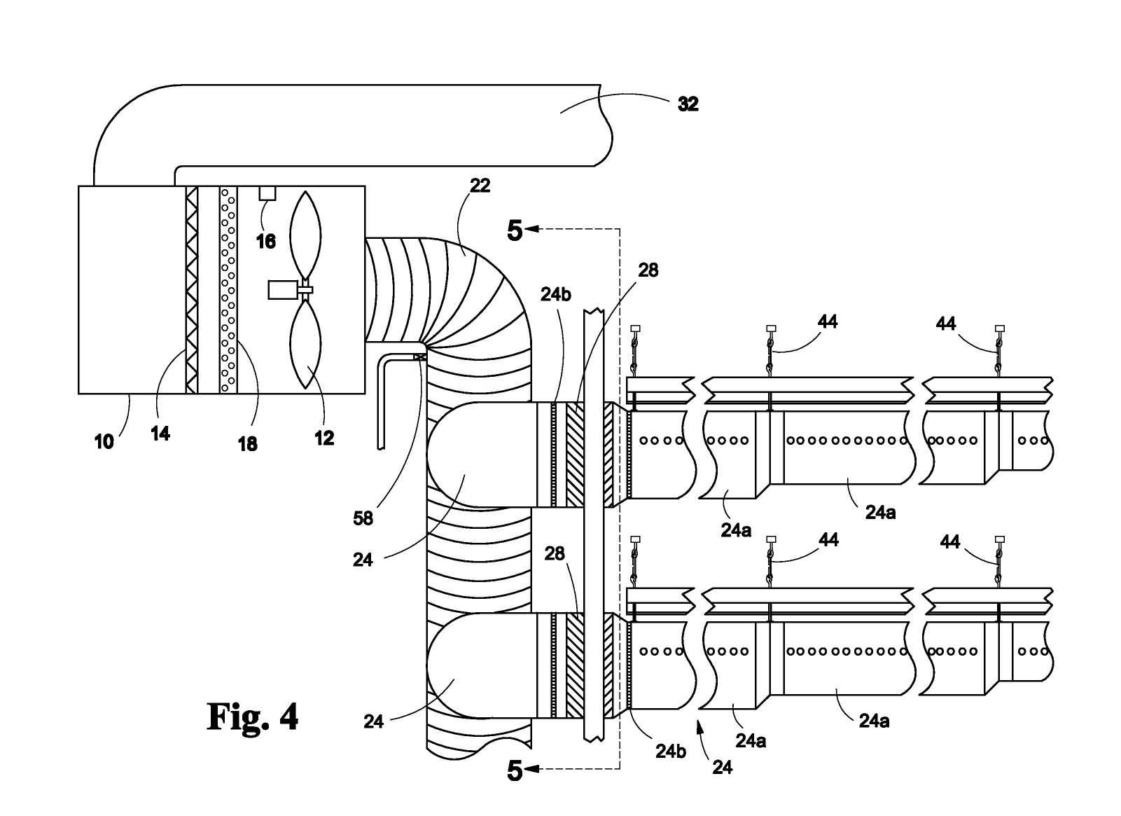

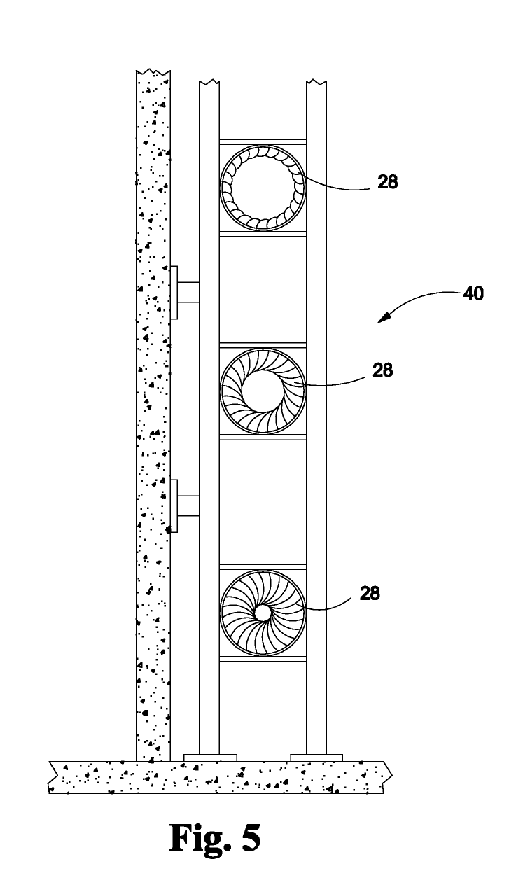

Referring to FIG. 1 through 6, the present invention includes an air flow distribution system. The air flow distribution system includes a multi-level rack 100, an air exchange unit 10, an air delivery structure 20, low pressure zone 108 and an air exhaust structure 30. The air exchange unit 10 includes a blower 12 that blows air into the air delivery structure 20. The air delivery structure 20 delivers directed streams of cold air in between the plants 104 and lights 106 supported by the multi level rack 100. The cold air pushes warm air produced by the lights 106 out of the multi-level rack 100 into the low-pressure zone 108. The warm air rises in the low-pressure zone 108 into the air exhaust structure 30 and may be directed to the air exchange unit 10 to be recycled within the air flow distribution system.

The present invention may include one or more multi-level racks 100. Each multi level rack 100 includes a first side, a second side opposite the first side, a front end, a rear end and a plurality of levels 102. The levels 102 may be disposed vertically below and above one another. Each of the levels 102 support plants 104 and include lights 106 disposed above the plants 104 and positioned to direct light towards the plants 104. The lights 106 may be supported by a bottom side of the level above the plants 104. The lights 106 of the present invention may include, but are not limited to, incandescent lights, fluorescent lights, high pressure sodium lights (HSP), metal, haloid lights (MH), light emitting diodes (LEDs) and the like. Each level may provide about 30 cm up to about 80 cm, such as about 50 cm, between the lights 106 and the plants 104.

The air exchange unit 10 includes a blower 12 to deliver air to the air flow distribution system. As illustrated in the Figures, the blower 12 may be a fan with propellers. The air exchange unit 10 may exchange stale air from the air exhaust structure 30 with fresh cool air through the air delivery structure 20. In certain embodiments, the air exchange unit 10 may further include a filter 14, such as a hepa filter and an ultra violet light 16 to kill bacteria. The air exchange unit 10 may further include a heating and/or cooling element 18. When air is drawn from the outside environment, the air may need to be cooled or heated depending on the outside temperature as well as the optimal temperature to maintain the plants' 104 health.

The air delivery structure 20 may include a main pipe 22, a plurality of delivery pipes 24 and CO2 solenoid valves 58. The main pipe 22 may be made of stainless steel, galvanized piping, aluminum or another type of metal. The main pipe 22 is connected to the air exchange unit 10 and receives air from the blower 12. The delivery pipes 24 are connected to the main pipe 22 at a proximal end and may include an end cap at a distal end. The plurality of delivery pipes 24 run from the main pipe 22 to the first side of the multi level rack 100. Each of the plurality of delivery pipes 24 is disposed horizontally along a different level from the rear side to the front side of the multi level rack 100 to deliver streams of air to each level 102. Therefore, the number of fresh air delivery pipes 24 may equal the number of levels 102. The plurality of outlets 26 includes a plurality of nozzles disposed along the length of each of the plurality of delivery pipes 24. The nozzle size and spacing are determined by the length of the throw i.e. the length of the levels 102 from the wall to the center of the room. For example, in 40 feet wide room the level 102 width on each side of the multilayer levels 102 is approximately 14 feet. The nozzles project a pressurized directed stream of fresh air in between the levels 102 of the rack 100 and the existing warmer air is pushed out towards the low-pressure zone 108 of the air exhaust structure 30. The CO2 solenoid valves 58 may be disposed at every three growing levels 102 and may deliver CO2 to the plants 104.

In certain embodiments, each of the delivery pipes 24 may be made of stainless steel, galvanized piping, aluminum or an anti-microbial fabric material. Each of the plurality of delivery pipes 24 may include a plurality of sections 24a. The sections 24a may be in lengths of about 5 ft. up to about 15 ft., such as about 10 ft. The plurality of sections 24a may reduce in diameter from the proximal end to the distal end of each of the plurality of delivery pipes 24. Due to the tapered diameter, as the air stream is delivered through the nozzles, the air pressure within the pipe 24 is maintained along the length of the pipe 24. In certain embodiments, the plurality of sections 24a may be releasably secured to one another by an air tight connector 24b, such as a zipper. Therefore, the fabric pipes 24 may be taken apart and removed from the air flow distribution system to be routinely washed in a washing machine to keep the pipes 24 sterile. When using a spare set of pipes 24, the hanging pipes 24 may be exchanged in minutes without interrupting the growth cycle. Further, in the event of a mechanical failure of the multi-level growing rack system or its irrigation system, the fabric pipes 24 may be easily removed allowing maintenance staff to access the levels 102 along the outer side of the racks 100.

The present invention may further include a delivery pipe support 40 operable to support each of the pipes 24 along each of the respective levels 102. The delivery pipe support 10 includes a support structure 41. The support structure 41 may be disposed adjacent to the first side of the multi level rack 100. The support structure 41 may include an upright support frame and horizontal support bars. Each of the plurality of delivery pipes 24 may hang from the support bars by a plurality of tethers 44. In certain embodiments, each of the plurality of tethers 44 are adjustable in length. Since the tethers 44 are adjustable, the pipes 24 may be precisely adjusted relative to the growing levels 102 so that the nozzles 26 are positioned at the ideal height to focus the air flow in between the lights 106 and over the plants 104. When a new plant 104 is chosen to grow, and has a different height than the previous plant 104 the adjustment is simple and quick by raising or lowering the tethers 44 that are supporting the pipes 24.

In certain embodiments, the delivery pipes 24 may slide along the support structure 41 to a retracted form and back to an expanded form. In such embodiments, a plurality of tracks 42 hang by the plurality of tethers 44. Each of the plurality of delivery pipes 24 is slidably engaged to a different track 42 of the plurality of tracks 42. The delivery pipes 24 may be attached the tracks 42 by brackets with rollers 46 that roll within the tracks 42. The tracks 42 may run from the rear to the front of the multi-level rack 100. The delivery pipes 24 slide along the track 42 to the expanded form and deliver streams of air in between the plants 104 and the lights 106. When the delivery pipes 24 need to be washed, the delivery pipes 24 may slide back along the track 42 to the retracted form and removed to be washed. To aid in sliding the delivery pipes 24 along the tracks 42, the present invention may further include a plurality of pulleys 48. A cord 49 is attached to each of the delivery pipes 24 and runs through each of the pulleys 48. A user may thereby pull on the cord 49 to retract and expand the delivery pipes 24.

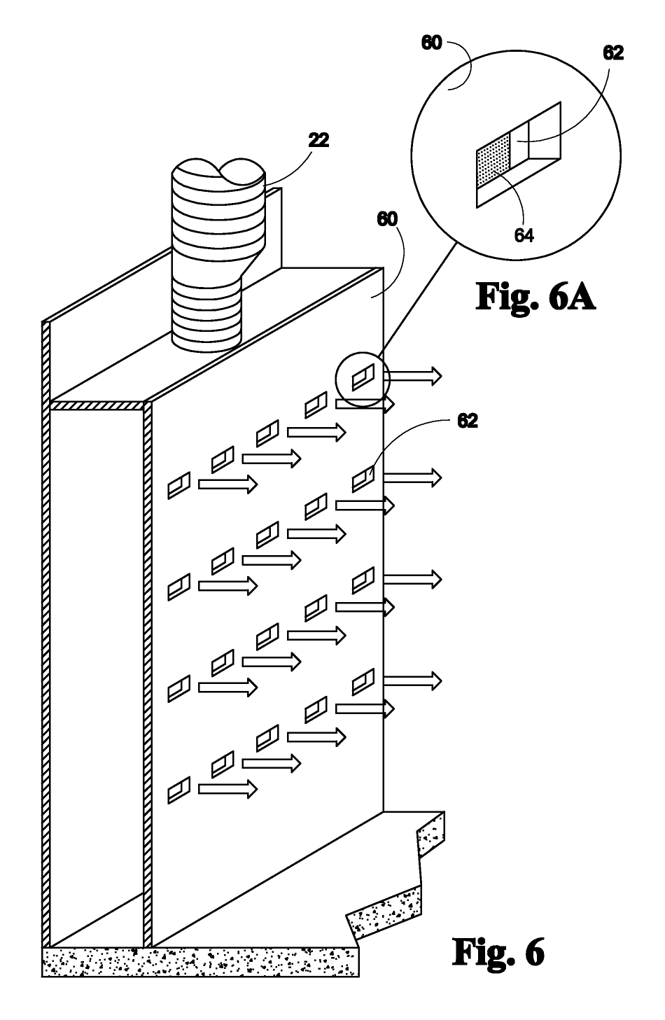

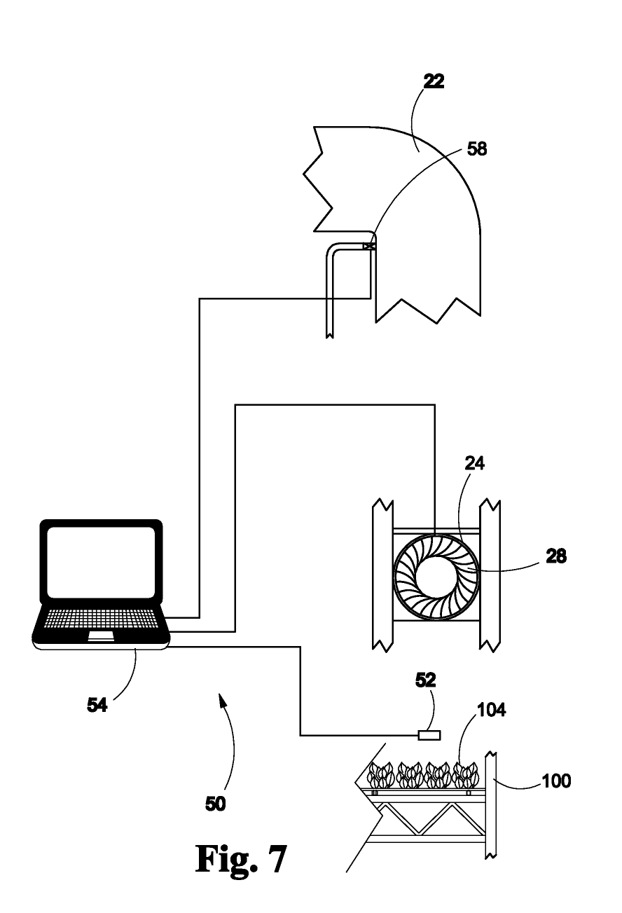

As illustrated in FIGS. 6 and 6a, the air delivery structure 20 may include a main pipe 22 and an air vent 60. The main pipe 22 may deliver air from the air exchange unit 10 to the air vent 60. The air vent 60 may be in the form of a box and may include a front surface, side walls, top and bottom walls, and a rear surface forming an airtight enclosure. The main pipe 22 may deliver air through the top wall. A plurality of openings 62 may be formed through the front surface. The plurality of openings 62 may form a plurality of rows aligned horizontally above and below one another. Each of the plurality of rows may be disposed at a different level 102 of the multi-level rack 100 and may deliver air in between the plants 104 and the lights 106. Each of the plurality of openings 62 may include a manual or automated sliding damper 64 to provide more or less air flow through each of the openings 62.

The air exhaust structure 30 of the present invention may include an exhaust pipe 32 and a plurality of inlets 34 leading into the exhaust pipe 32. The exhaust pipe 32 may be secured to a ceiling of the grow room containing the multi-level racks 100. Once the warm air is pushed out of the multi-level racks 100, into the low-pressure zone 108 the warm air naturally rises into the plurality of inlets 34. The exhaust pipe 32 may be directly connected to the air exchange unit 10. In such embodiments, the blower 12 may create a vacuum within the exhaust pipe 32 and thereby pushes the warm stale air from the exhaust pipe 32 into the air exchange unit 10 to be cooled and recycled.

In certain embodiments, the present invention may include a plurality of multi-level racks 100. An air flow distribution system may service a pair or more multi-level racks 100, such as a first rack 100 and a second rack 100. In such embodiments, the plurality of delivery pipes 24 includes a first set of pipes 24 disposed alongside the first side of the first rack 100 and a second set of pipes 24 disposed alongside the first side of the second rack 100. The air exhaust structure 30 may be secured to the ceiling of the grow room in between the first rack 100 and the second rack 100. The stream of air is delivered in between the levels 102 of the outer sides of the racks 100 towards one another to the low-pressure zone 108 in between the racks 100. The warm air then rises from in between the racks 100 and into the air exhaust structure 30. Thus, creating a push pull horizontal air cooling distribution system.

The present invention may further include an air flow control system 50. The air flow control system 50 may include a plurality of sensors 52, a plurality of dampers 28 and/or slide dampers 64, the plurality of CO2 solenoid valves 58 and a computer 54. The sensors 52 may be disposed in between the levels 102 and may measure at least one of a temperature, a humidity and a level of CO2. In certain embodiments, one sensor 52 may be utilized for every three levels 102. For example, the sensor 52 may be in the middle level 102 of a three level 102 set. The sensor 52 may hang above the plants 104. Each of the delivery pipes 24 may include a damper 28 that varies the diameter of the passageway within the pipes 24, and thereby stops or regulates the flow of air inside of the delivery pipe 24. The computer 54 is operable to receive data from the sensors 52 and adjust the plurality of dampers 28 and CO2 solenoid valves 58 based on the received data. For example, if the sensors 52 detect warmer temperatures within a growing level 102, the damper 28 is opened to a wider diameter to allow more air flow through the growing level 104 to cool the growing level 102. If the sensors 52 detect cooler temperatures within a growing level 102, the damper 28 is closed to a smaller diameter to allow less air flow through the growing level 104. The air flow control system creates a balanced cooling environment regardless of whether the plants 104 are growing on the ground level or near the ceiling.

It should be understood, of course, that the foregoing relates to exemplary embodiments of the invention and that modifications may be made without departing from the spirit and scope of the invention as set forth in the following claims.

What is claimed is:

1. An air flow distribution system comprising:
at least one multi-level rack comprising a first side, a second side opposite the first side, and plurality of levels, wherein each level is configured to support a plurality of plants and a plurality of lights positioned to direct light towards the plurality of plants;
an air exchange unit comprising a blower;
an air delivery structure receiving air from the blower, wherein the air delivery structure comprises at least a portion disposed on the first side of the multi level rack comprising a plurality of outlets positioned to deliver a stream of air in between the plurality of plants and the plurality of lights; and
an air exhaust structure disposed on the second side above the at least one multi level rack and comprising at least one inlet.

2. The air flow distribution system of claim 1, wherein the air exhaust structure is connected to the air exchange unit and the blower forms a vacuum within the air exhaust structure.

3. The air flow distribution system of claim 2, wherein the air exhaust structure comprises an exhaust pipe comprising a plurality of inlets.

4. The air flow distribution system of claim 1, wherein the air exchange unit further comprises at least one of an ultra violet light and a filter.

5. The air flow distribution system of claim 1, wherein the air exchange unit further comprises at least one of a heating element and a cooling element.

6. The air flow distribution system of claim 1, wherein the air delivery structure comprises:
a main pipe running from the air exchange unit and receiving air from the blower; and
a plurality of delivery pipes running from the main pipe to the first side of the at least one multi level rack, wherein
each of the plurality of delivery pipes is disposed horizontally along a different level, and
the plurality of outlets is a plurality of nozzles disposed along the length of each of the plurality of delivery pipes.

7. The air flow distribution system of claim 6, wherein the at least one multi level rack comprises a first rack and a second rack, wherein the plurality of delivery pipes comprises a first set of pipes disposed alongside the first side of the first rack and a second set of pipes disposed alongside the first side of the second rack, wherein the air exhaust structure is disposed in between the first rack and the second rack.

8. The air flow distribution system of claim 6, wherein the plurality of delivery pipes are made of a fabric material.

9. The air flow distribution system of claim 8, further comprising a delivery pipe support comprising a support structure, wherein each of the plurality of delivery pipes are hanging from the support structure by a plurality of tethers.

10. The air flow distribution system of claim 9, wherein each of the plurality of tethers are adjustable in length.

11. The air flow distribution system of claim 9, wherein the delivery pipe support further comprises a plurality of tracks hanging by the plurality of tethers, wherein each of the plurality of delivery pipes is slidably engaged to a different track of the plurality of tracks.

12. The air flow distribution system of claim 11, wherein the delivery pipe support further comprises a plurality of pulleys operable to slide the plurality of pipes along the plurality of tracks.

13. The air flow distribution system of claim 6, wherein each of the plurality of delivery pipes comprise a plurality of sections, wherein the plurality of sections reduces in diameter from a proximal end to a distal end of each of the plurality of delivery pipes.

14. The air flow distribution system of claim 13, wherein the plurality of sections are releasably attached together by an air tight connector.

15. The air flow distribution system of claim 14, wherein the air tight connector is a zipper.

16. The air flow distribution system of claim 1, further comprising an air flow control system comprising:
a plurality of sensors disposed within the plurality of levels, wherein the plurality of sensors measure at least one of a temperature, a humidity and a level of CO2;
a plurality of dampers, wherein each of the plurality of delivery pipes comprises a different damper of the plurality of dampers;
a computer operable to receive data from the at least one sensor and adjust the plurality of dampers based on the received data.

17. An air flow distribution system comprising:
an air exchange unit comprising a blower;
a main pipe running from the air exchange unit and receiving air from the blower;
a plurality of delivery pipes running from the main pipe and disposed horizontally above and below one another, wherein each of the delivery pipes comprises a plurality of nozzles disposed along a length of the plurality of delivery pipes, wherein the nozzles are operable to deliver a stream of air in between a plurality of plants and a plurality of lights within a multi level rack; and
an air exhaust structure comprising at least one inlet, wherein the air exhaust structure is connected to the air exchange unit and the blower forms a vacuum within the air exhaust structure.

18. The air flow distribution system of claim 17, wherein the plurality of delivery pipes are made of a fabric material.

19. The air flow distribution system of claim 18, further comprising a delivery pipe support comprising:
a support structure;
a plurality of tracks hanging from the support structure by a plurality of tethers, wherein each of the plurality of delivery pipes is slidably engaged to a different track of the plurality of tracks; and
a plurality of pulleys operable to slide the plurality of pipes along the plurality of tracks.

20. The air flow distribution system of claim 17, further comprising an air flow control system comprising:
a plurality of sensors operable to measure at least one of a temperature, a humidity and a level of CO2;
a plurality of dampers, wherein each of the plurality of delivery pipes comprises a different damper of the plurality of dampers; and
a computer operable to receive data from the at least one sensor and adjust the plurality of dampers based on the received data.
